(19) United States
(12) Patent Application Publication
(10) Pub. No.: US 2004/0151375 A1
(43) Pub. Date: Aug. 5, 2004

(54) Method of digital image analysis for isolating a teeth area within a teeth image and personal identification method and apparatus using the teeth image

(75) Inventors: Tae-woo Kim, Seongnam-si (KR); Gil-won Yoon, Seoul (KR)

Correspondence Address: LEE & STERBA, P.C., Suite 2000, 1101 Wilson Boulevard, Arlington, VA, 22209, US

(73) Assignee: Samsung Electronics Co., Ltd.

(21) Appl. No.: 10/746,258

(22) Filed: Dec. 29, 2003

(30) Foreign Application Priority Data
Dec. 28, 2002 (KR) 2002-85916

(51) Int. Cl. G06K 9/00; G06K 9/34

(52) U.S. Cl. 382/181; 382/173; 382/128

(57) ABSTRACT

A personal identification method using a digital image of teeth of a person to be identified including constructing a database by storing teeth images from a plurality of persons and at least one corresponding teeth characteristic element of each person; determining a position of an interline between an upper teeth portion and a lower teeth portion from an inner mouth area that is separated from a teeth image of the person to be identified, and isolating an upper teeth area and a lower teeth area based on the position of the interline; identifying one or more teeth characteristic elements from the upper and lower teeth areas; and searching the database based on the identified one or more teeth characteristic elements and determining identification pass or fail according to a similarity between the teeth image of the person to be identified and a teeth image retrieved from the database.

### BACKGROUND OF THE INVENTION

1. Field of the Invention

The present invention relates to personal identification technology. More particularly, the present invention relates to a method of digital image analysis for isolating a teeth area within a teeth image, and a personal identification method and apparatus using characteristic elements of the isolated teeth area.

2. Description of the Related Art

Personal identification may be performed to permit access to a particular area, such as a security area, using recognition of a person's face, fingerprint, iris, veins in the back of a hand, or voice. Each of these methods, however, has disadvantages. For example, a complex algorithm is required to perform face recognition and expensive equipment is required to perform iris recognition. In addition, it is difficult to recognize a fingerprint when the fingerprint is not clear or when a finger is stained with a foreign substance or wet due to the presence of perspiration. Further, vein patterns in the back of a hand may vary with circumstances. Accordingly, a personal identification method using a part of the body that rarely changes and an image thereof, which may be analyzed using simple and inexpensive software and hardware is desired.

### SUMMARY OF THE INVENTION

The present invention provides a method of digital image analysis for isolating a teeth area within a teeth image of a person to be identified.

The present invention also provides a personal identification method and apparatus using a teeth image that rarely changes and may be simply analyzed.

According to a feature of an embodiment of the present invention, there is provided a method of digital imaging for isolating a teeth area within a teeth image including providing a teeth image of a person to be identified, isolating an inner mouth area within the teeth image, determining a position of an interline between an upper teeth portion and a lower teeth portion within the inner mouth area, and isolating an upper teeth area and a lower teeth area based on the position of the interline.

In the method, isolating the inner mouth area may include defining first regions and second regions by performing thresholding on each pixel of the teeth image using a predetermined threshold value, labeling contour portions of the second regions smaller than the first regions, and selecting a region having a maximum area from among the labeled second regions and determining the selected region as the inner mouth area. Defining the first and second regions may include performing thresholding using at least one among red (R), green (G), and blue (B) color values of each pixel in the teeth image or converting RGB color values of each pixel in the teeth image into Hue Saturation Intensity (HSI) color values and performing the thresholding using a converted I color value.

In the method, determining the position of the interline may include performing horizontal projection on the inner mouth area, and determining the position of the interline based on a position at which a pixel accumulation value is at a maximum as the result of the horizontal projection.

In the method, isolating the upper and lower teeth areas may include extending an area having a similar color to each of seed points, which are respectively set at predetermined positions above and below the interline from the seed point. Isolating the upper and lower teeth areas may also include setting a predetermined upper area and a predetermined lower area to have a rectangular shape based on the position of the interline, and performing thresholding on the predetermined upper and lower areas using a predetermined threshold value.

According to another feature of an embodiment of the present invention, there is provided a computer readable recording medium including a first program for performing thresholding on a teeth image of a person to be identified using a predetermined threshold value and selecting a region having a maximum area from regions that are defined by performing labeling on thresholded pixels, thereby isolating an inner mouth area within the teeth image recorded thereon; a second program for performing horizontal projection on the inner mouth area and determining a position of an interline between an upper teeth portion and a lower teeth portion based on a position at which a pixel accumulation value is at a maximum as the result of the horizontal projection recorded thereon; and a third program for isolating upper and lower teeth areas based on the position of the interline recorded thereon.

According to still another feature of an embodiment of the present invention, there is provided a personal identification method using a digital image of teeth of a person to be identified including constructing a database by storing teeth images from a plurality of persons and at least one corresponding teeth characteristic element of each person; determining a position of an interline between an upper teeth portion and a lower teeth portion from an inner mouth area that is separated from a teeth image of the person to be identified, and isolating an upper teeth area and a lower teeth area based on the position of the interline; identifying one or more teeth characteristic elements from the upper and lower teeth areas; and searching the database based on the identified one or more teeth characteristic elements and determining identification pass or fail according to a similarity between the teeth image of the person to be identified and a teeth image retrieved from the database.

In the method, determining the position of the interline may include performing thresholding on each pixel in the teeth image using a predetermined threshold value, labeling the thresholded pixels, and selecting a region having a maximum area from among regions defined as a result of the labeling, as the inner mouth area. Determining the position of the interline may also include performing horizontal projection on the inner mouth area, and determining the position of the interline based on a position at which a pixel accumulation value is at a maximum as the result of the horizontal projection. Determining the position of the interline may further include extending an area having a similar color to each of seed points, which are respectively set at predetermined positions above and below the interline, from a respective seed point in order to isolate the upper and lower teeth areas. Determining the position of the interline may still further include setting a predetermined upper area and a predetermined lower area to have a rectangular shape based on the position of the interline and performing thresholding on the predetermined upper and lower areas, in order to isolate the upper and lower teeth areas.

In the method, performing the thresholding may include using at least one among red (R), green (G), and blue (B) color values of each pixel in the teeth image. In the method, RGB color values of each pixel in the teeth image may be converted into Hue Saturation Intensity (HSI) color values, and the thresholding may be performed using a converted I color value.

In the method, identifying one or more teeth characteristic elements may include performing vertical projection on each of the isolated upper and lower teeth areas and obtaining information on the number of teeth in the upper and lower teeth areas, an area ratio between teeth, and a width ratio between teeth from the result of the vertical projection. Identifying one or more teeth characteristic elements may also include obtaining information on shapes of teeth and teeth arrangement from an image pattern of the isolated upper and lower teeth areas or obtaining information on colors of teeth by obtaining a brightness histogram of the isolated upper and lower teeth areas.

In the method, searching the database may include searching the database using one of the detected teeth characteristic elements to identify candidate teeth images, and searching the candidate teeth images using at least one teeth characteristic element from among the remaining teeth characteristic elements.

According to yet another feature of an embodiment of the present invention, there is provided a computer readable recording medium including a first program for constructing a database by storing teeth images from a plurality of persons and at least one corresponding teeth characteristic element of each person recorded thereon; a second program for determining a position of an interline between an upper teeth portion and a lower teeth portion from an inner mouth area that is isolated from a teeth image of a person to be identified, and isolating an upper teeth area and a lower teeth area based on the position of the interline recorded thereon; a third program for identifying one or more teeth characteristic elements from the upper and lower teeth areas; and a fourth program for searching the database based on the identified one or more teeth characteristic elements and determining identification pass or fail according to a similarity between the teeth image of the person to be identified and a teeth image retrieved from the database.

According to still another feature of an embodiment of the present invention there is provided a personal identification apparatus using a teeth image, including a teeth image database, which stores teeth images from a plurality of persons and at least one corresponding teeth characteristic element of each person; a teeth image acquisition unit for acquiring a teeth image of a person to be identified; a teeth isolator for performing a first thresholding on the teeth image provided from the teeth image acquisition unit to separate an inner mouth area, for performing horizontal projection on the inner mouth area to determine a position of an interline between an upper teeth portion and a lower teeth portion, and for isolating a teeth area based on the position of the interline; a characteristic detector for performing vertical projection on the isolated teeth area to identify one or more teeth characteristic elements; a search section for searching the teeth image database using at least one of the teeth characteristic elements identified by the characteristic detector; and an identification section for determining identification pass or fail according to a similarity between the teeth image of the person to be identified and a teeth image searched from the search section.

In the apparatus, the teeth isolator may extend an area having a similar color to each of seed points, which are respectively set at predetermined positions above and below the interline, from a respective seed point in order to isolate the teeth area. The teeth isolator may set a predetermined upper area and a predetermined lower area to have a rectangular shape based on the position of the interline and perform a second thresholding on the predetermined upper and lower areas to isolate the teeth area. The characteristic detector may obtain a brightness histogram of the isolated teeth area in addition to the vertical projection on the teeth area. The search section may search the teeth image database using one of the identified teeth characteristic elements to identify candidate teeth images, and search only the candidate teeth images using at least one teeth characteristic element from among the remaining teeth characteristic elements.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a block diagram of a personal identification apparatus using a teeth image according to a preferred embodiment of the present invention;

FIG. 2 is a detailed block diagram of a teeth image processing unit shown in FIG. 1;

FIG. 3 is a flowchart showing operations performed by a teeth isolator shown in FIG. 2;

FIGS. 4A through 4F are diagrams showing the results of the operations shown in FIG. 3;

FIGS. 5A and 5B are diagrams for explaining the operation of a characteristic detector shown in FIG. 2;

FIGS. 6A and 6B are examples of teeth images used for segmenting a teeth area and identifying characteristic elements according to an embodiment of the present invention;

FIGS. 7A and 7B are examples of upper and lower teeth areas isolated from the teeth areas shown in FIGS. 6A and 6B, respectively;

FIGS. 8A and 8B are graphs showing results of performing vertical projection on the upper teeth areas shown in FIGS. 7A and 7B, respectively; and

FIGS. 9A and 9B are graphs showing results of performing vertical projection on the lower teeth areas shown in FIGS. 7A and 7B, respectively.

### DETAILED DESCRIPTION OF THE INVENTION

Korean Patent Application No. 2002-85916, filed on Dec. 28, 2002, and entitled: “Method of Isolating a Teeth Area Within a Teeth Image and Personal Identification Method and Apparatus Using the Same,” is incorporated by reference herein in its entirety.

The present invention will now be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

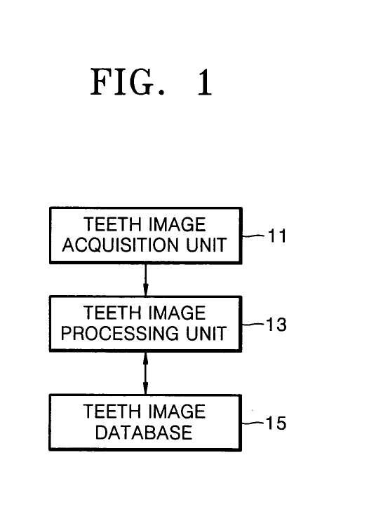

FIG. 1 is a block diagram of a personal identification apparatus using a teeth image according to a preferred embodiment of the present invention. The personal identification apparatus includes a teeth image acquisition unit 11, a teeth image processing unit 13, and a teeth image database 15.

The teeth image acquisition unit 11 is usually composed of a digital camera, such as a camera exclusively for photographing teeth, a camera attached to a personal computer, or a camera attached to a mobile communication terminal. When personal identification is required, the teeth image acquisition unit 11 photographs a front view of teeth of a person to be identified to acquire a teeth image and provides the teeth image to the teeth image processing unit 13. Preferably, the teeth are photographed in a state in which the upper teeth are separated from the lower teeth in order to facilitate the isolation of an upper teeth area and a lower teeth area.

The teeth image processing unit 13 isolates a teeth area within the teeth image provided from the teeth image acquisition unit 11 by performing a thresholding process, a projection process, and an area growth process. Subsequently, the teeth image processing unit 13 identifies characteristic elements of the teeth and searches the teeth image database 15 based on the identified characteristic elements. Various methods may be used to identify the person. For example, a similarity in each characteristic element between a currently input teeth image and a teeth image from the teeth image database 15 is calculated. Identification succeeds when the teeth image database 15 includes a teeth image having a similarity in each teeth characteristic element, or an average of similarities with respect to all of the teeth characteristic elements that exceeds a predetermined reference value. On the contrary, identification fails when the teeth image database 15 does not include such a teeth image. The predetermined reference value may be optimally set through experimentation or simulation.

The teeth image database 15 is constructed by acquiring teeth images from many persons and storing them along with corresponding personal information, including a personal identifier, teeth information, and the characteristic elements of the teeth. In addition to a front view of the teeth, various alternate views thereof may be stored. The characteristic elements of teeth include the shapes and colors of the teeth, an area ratio between teeth, a width ratio between teeth, and a teeth arrangement.

The personal identification apparatus of the present invention may be implemented in personal mobile communication equipment, such as a cellular phone or a personal digital assistant (PDA), so that it may be used for personal identification when security is required. Security may be required, for example, when the personal mobile communication equipment is lost or when electronic payment is to be performed through the personal mobile communication equipment. In this situation, the teeth image database 15 stores the teeth image of the owner of the mobile communication equipment along with the owner's personal information, teeth information, and characteristic elements of the teeth.

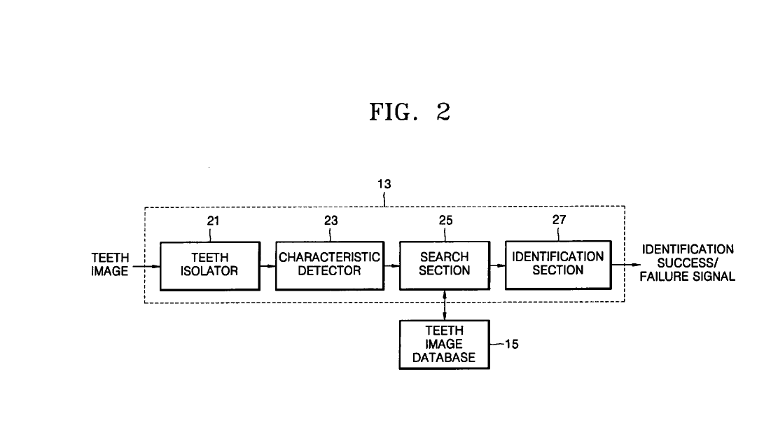

FIG. 2 is a detailed block diagram of the teeth image processing unit 13 shown in FIG. 1. The teeth image processing unit 13 includes a teeth isolator 21, a characteristic detector 23, a search section 25, and an identification section 27.

The teeth isolator 21 isolates a teeth area within a teeth image provided by the teeth image acquisition unit 11. The teeth isolator 21 separates an inner area of a mouth within the teeth image, determines a position of an interface between an upper teeth portion and a lower teeth portion, and isolates a teeth area based on the interface between the upper and lower teeth portions.

The characteristic detector 23 identifies characteristic elements for identifying an individual's teeth from the teeth area isolated by the teeth isolator 21. Identifiable characteristic elements include the shapes and colors of teeth, an area ratio between teeth, a width ratio between teeth, and a teeth arrangement.

Teeth shape and arrangement information may be obtained from an image pattern of the isolated teeth area. Information on the area ratio and the width ratio between the teeth may be obtained by performing vertical projection on the teeth area. Teeth color information may be obtained by performing a histogram process on the brightness of the teeth area.

The search section 25 searches the teeth image database 15 using the teeth characteristic elements identified by the characteristic detector 23. In operation, not all of the teeth characteristic elements are simultaneously used. Rather, a search using a particular teeth characteristic element that requires a short processing time in a projection image, such as a width ratio between teeth, is performed initially to identify candidate teeth images having similarities that exceed a reference value. Thereafter, the search section 25 searches only the candidate teeth images using the remaining teeth characteristic elements. The reference value may be optimally set through experimentation or simulation.

The identification section 27 determines whether the identification has succeeded. For identification to be a success, a teeth image is found that has a similarity in each teeth characteristic element, or an average of similarities with respect to all of the teeth characteristic elements, that exceeds a reference value as the result of the search performed by the search section 25. When such a teeth image is not found, the identification section 27 determines that the identification has failed. The identification section 27 outputs a signal corresponding to the result of the determination.

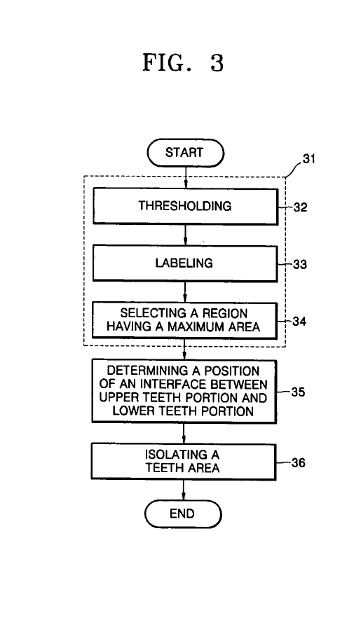

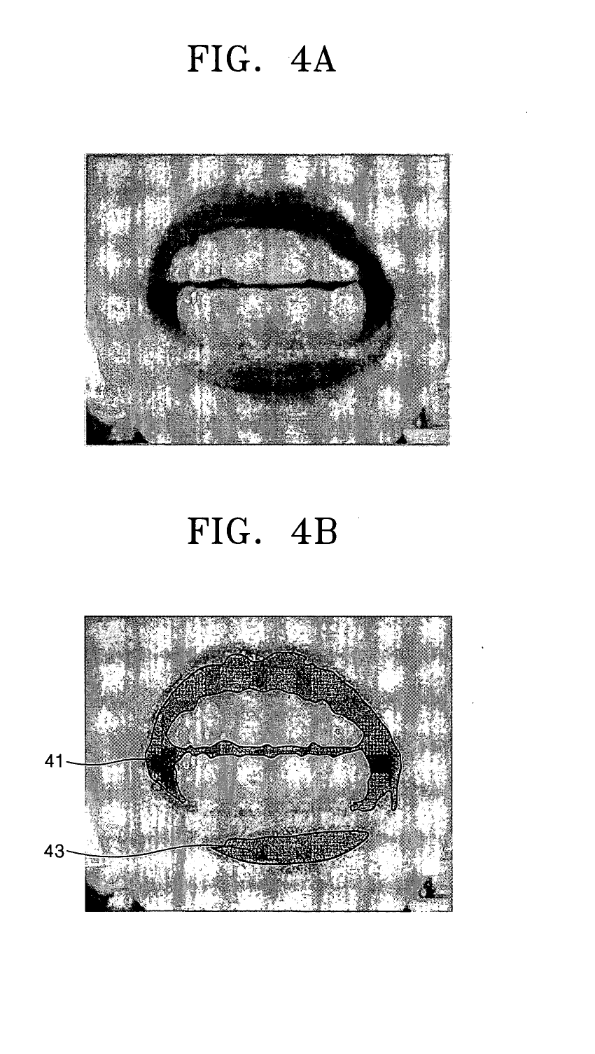

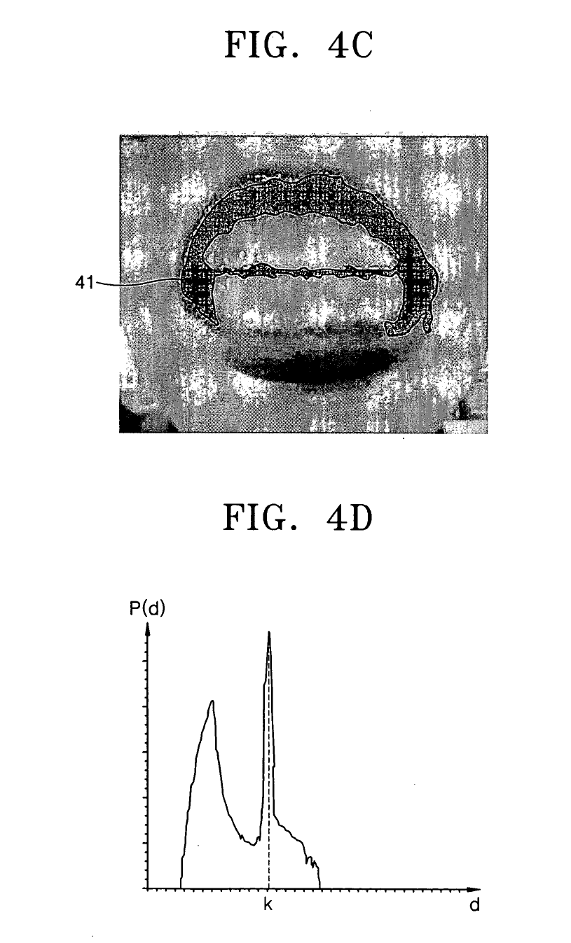

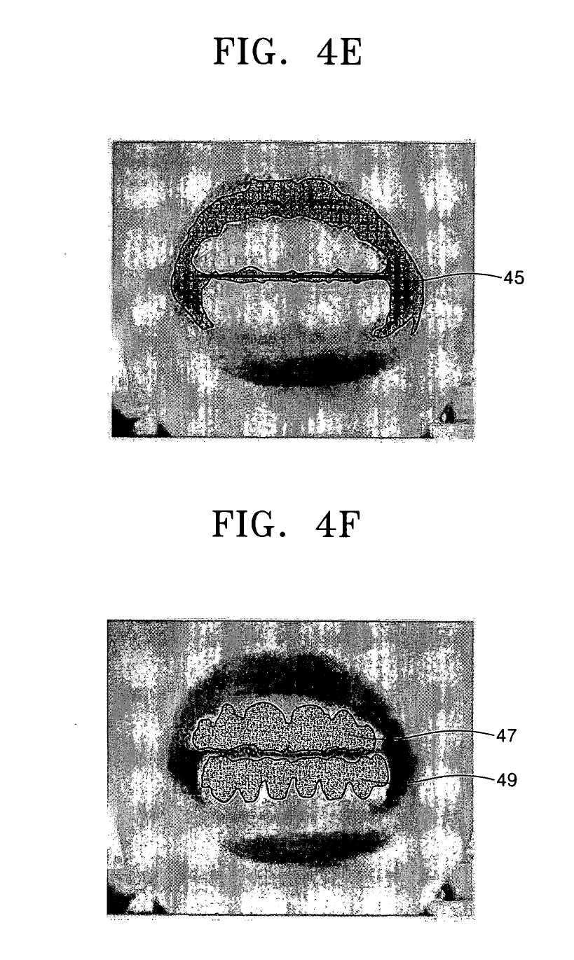

FIG. 3 is a flowchart showing operations performed by the teeth isolator 21 shown in FIG. 2. In steps 31, 35, and 36, the teeth isolator 21 isolates an inner area of a mouth, determines a position of an interface between an upper teeth portion and a lower teeth portion, and isolates a teeth area, respectively. The operations shown in FIG. 3 will be described with reference to FIGS. 4A through 4F.

Step 31 is provided in order to isolate the inner area of a mouth from a teeth image and includes the steps of thresholding 32, labeling 33, and selecting a region having a maximum area 34.

In step 32, thresholding is performed on a teeth image as shown in FIG. 4A using Formula 1:

g(x)=1, ƒ(x)≦T

g(x)=0, ƒ(x)>T (1)

where, ƒ(x) is a pixel value at a pixel position x in the teeth image and 0≦ƒ(x)≦255, and g(x) is a pixel value indicating the inner area of a mouth and may have a value of 0 or 1. T is a threshold value, for example, 70, and may be obtained through experimentation. In the meantime, at least one among the red (R), green (G), and blue (B) color values of each pixel or a converted I color value I(x) corresponding to a brightness in a Hue Saturation Intensity (HSI) color coordinate system may be used as ƒ(x). In order to obtain the converted I color value I(x) from the R, G, and B color values, an RGB/HSI color coordinate system conversion formula shown in Formula 2 is used. Preferably, the RGB and HSI color coordinate systems are used, but other various color coordinate systems such as CMY, YIQ, and HSV color coordinate systems may also be used.

$$\begin{matrix}I = F \frac{R + G + B}{3} \\ H = \frac{F}{2 π} {cos}^{- 1} \{ \frac{\frac{1}{2} [ ( R - G ) + ( R - B ) ]}{{[ {( R - G )}^{2} + ( R - B ) ( G - B ) ]}^{1 / 2}} \} \\ S = F \{ 1 - \frac{3}{R + G + B} min ( R , G , B ) \}\end{matrix} \qquad ( 2 )$$

where, 0≦R, G, B≦1, and F is a constant that is typically equal to 255. As a result of performing thresholding according to formula 1 on the teeth image of FIG. 4A provided by the teeth image acquisition unit 11, first regions set to 0 and second regions set to 1 are defined.

In step 33, labeling is performed on contour portions of the second regions smaller than the first regions so that regions 41 and 43, in which the value of g(x) for each pixel is 1, are separated, as shown in FIG. 4B.

In step 34, the region having a maximum area from among the regions 41 and 43 separated as a result of the labeling is selected so that the region 41 is separated as an inner mouth area within the teeth image of FIG. 4A, as shown in FIG. 4C.

In step 35, a graph shown in FIG. 4D is obtained by performing horizontal projection on the inner mouth area 41 separated in step 34 in order to determine a position of an interface between an upper teeth portion and a lower teeth portion within the teeth image. In FIG. 4D, an x-axis indicates a vertical distance d from a top to a bottom of the teeth image, and a y-axis indicates a thresholded pixel accumulation value P(d) at each position corresponding to the vertical distance d. As the result of performing the horizontal projection, a position k at which the pixel accumulation value P(d) is at a maximum is selected as a vertical distance corresponding to the interface between the upper teeth portion and the lower teeth portion. Here, it is preferable to make a teeth arrangement horizontal by rotating the teeth image such that a pixel accumulation value P(d) at the position k corresponding to the interface between the upper teeth portion and the lower teeth portion becomes a maximum peak. A position of an interline 45 is determined, as shown in FIG. 4E, based on the vertical distance k corresponding to the interface between the upper teeth portion and the lower teeth portion.

In step 36, an upper teeth area 47 and a lower teeth area 49 are isolated, as shown in FIG. 4F, by performing area growth based on the position of the interline 45 or by setting a predetermined upper area and a predetermined lower area to have a rectangular shape based on the position of the interline 45 and then performing thresholding on the predetermined upper and lower areas. When using an area growth method, seed points are set at predetermined positions, respectively, above and below the interline 45, referring to H(x) corresponding to a hue in the HSI color coordinate system, and an area having a similar color to each seed point is extended around the seed point. It is preferable to exclude black and red from the color of the seed point.

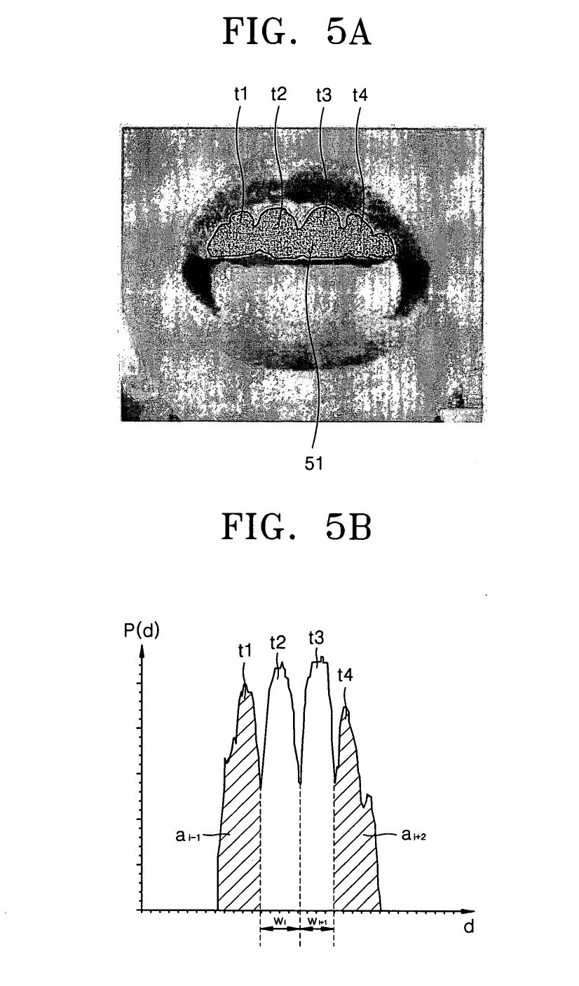

FIGS. 5A and 5B are diagrams for explaining the operation of the characteristic detector 23 shown in FIG. 2. A graph shown in FIG. 5B is obtained as a result of performing vertical projection on an upper teeth area 51 shown in FIG. 5A. In FIG. 5B, an x-axis indicates a horizontal distance d from left to right in a teeth image, and a y-axis indicates a thresholded pixel accumulation value P(d) at each position corresponding to the horizontal distance d. As the result of performing the vertical projection, four peaks having large pixel accumulation values P(d) are generated, and portions that are formed based on the four peaks, respectively, correspond to four teeth t1 through t4, respectively, that are central to the upper teeth area 51. By performing the vertical projection, the number of teeth, a tooth area (e.g., aᵢ₋₁ or aᵢ₊₂), an area ratio (e.g., aᵢ₋₁/aᵢ₊₂), a tooth width (e.g., wᵢ or wᵢ₊₁), and a width ratio (e.g., wᵢ/wᵢ₊₁) may be calculated.

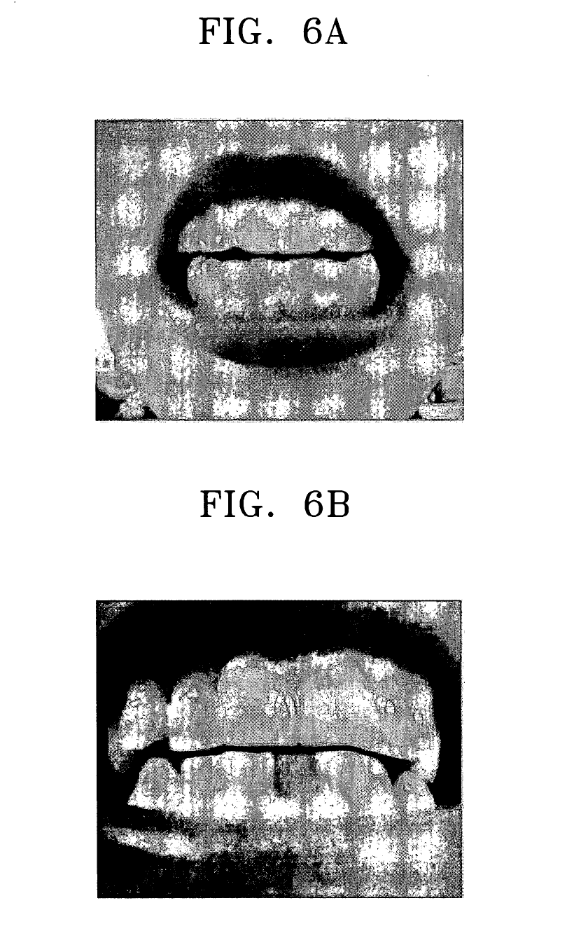

An exemplary personal identification method according to an embodiment of the present invention will now be described with reference to different persons' teeth images (referred to as object #1 and object #2, respectively) shown in FIGS. 6A and 6B, respectively.

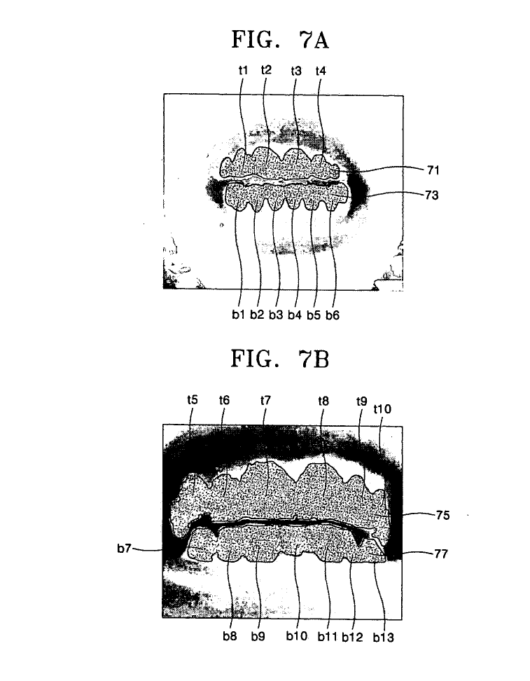

FIGS. 7A and 7B show upper teeth areas 71 and 75 and lower teeth areas 73 and 77, respectively, which are isolated by performing thresholding, labeling, selecting a region having a maximum area, performing vertical projection, and performing area growth on the teeth images shown in FIGS. 6A and 6B.

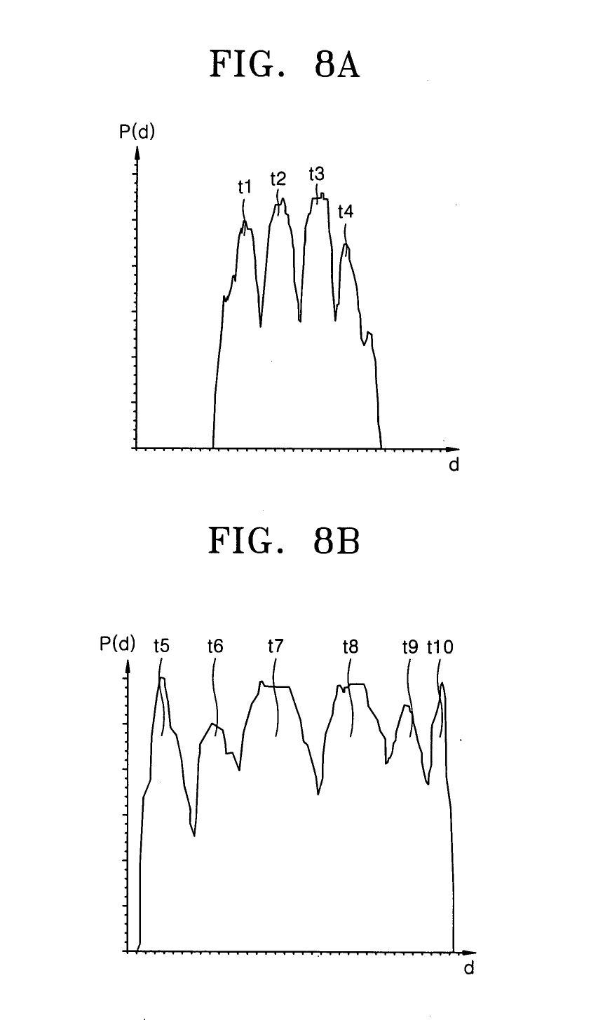

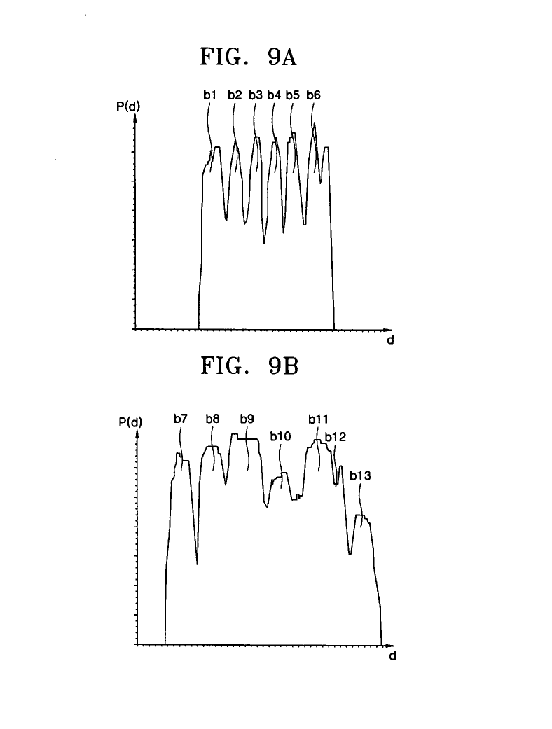

FIGS. 8A and 8B are graphs showing results of performing vertical projection on the upper teeth areas 71 and 75 shown in FIGS. 7A and 7B, respectively. FIGS. 9A and 9B are graphs showing results of performing vertical projection on the lower teeth areas 73 and 77 shown in FIGS. 7A and 7B, respectively. Referring to FIGS. 8A and 8B, teeth t1 through t4 are central to the upper teeth area 71 of the teeth image shown in FIG. 6A, and teeth t5 through t10 are central to the upper teeth area 75 of the teeth image shown in FIG. 6B. Referring to FIGS. 9A and 9B, teeth b1 through b6 are central to the lower teeth area 73 of the teeth image shown in FIG. 6A, and teeth b7 through b13 are central to the lower teeth area 77 of the teeth image shown in FIG. 6B.

In this personal identification method, the number of teeth, a central position of each tooth, and a width of each tooth, which are obtained through vertical projection, are used as teeth characteristic elements. These teeth characteristic elements may be calculated from FIGS. 8A through 9B, as shown in the following table.

| | | Number of | Central position | Width of |
|---|---|---|---|---|
| Object | | teeth | of each tooth | each tooth |
| Object #1 | Upper teeth | 4 | 116, 159, | 37, 42, |
| | | | 200, 236 | 39, 24 |
| | Lower teeth | 6 | 113, 144, 171, | 28, 20, 19, |
| | | | 198, 233, 259 | 20, 21, 31 |
| Object #2 | Upper teeth | 6 | 45, 94, 156, | 29, 26, 68, |
| | | | 237, 289, 322 | 63, 28, 17 |
| | Lower teeth | 7 | 65, 82, 155, | 29, 38, 50, |
| | | | 197, 250, 272, 287 | 28, 48, 7, 29 |

Referring to the above table, it may be concluded that people may have sufficiently different teeth characteristic elements to allow for personal identification using the teeth characteristic elements.

The present invention may be realized as program codes that are recorded on a computer readable recording medium and may be read by a computer. For example, a method of isolating a teeth area from a teeth image may be implemented by recording several programs on a computer readable recording medium. These several programs may include: a first program for performing thresholding on a teeth image of a person to be identified using a predetermined threshold value and selecting a region having a maximum area from regions that are defined by performing labeling on thresholded pixels, thereby isolating an inner mouth area within the teeth image; a second program for performing horizontal projection on the inner mouth area and determining a position of an interline between an upper teeth portion and a lower teeth portion based on a position at which a pixel accumulation value is at a maximum as the result of the horizontal projection; and a third program for isolating upper and lower teeth areas based on the position of the interline.

Alternately, a personal identification method using a teeth image may be implemented by recording several programs on a computer readable recording medium. These programs may include: a first program for constructing a database by storing teeth images from a plurality of persons and at least one corresponding teeth characteristic element of each person; a second program for determining a position of an interline between an upper teeth portion and a lower teeth portion from an inner mouth area that is isolated from a teeth image of a person to be identified, and isolating an upper teeth area and a lower teeth area based on the position of the interline; a third program for identifying one or more teeth characteristic elements from the upper and lower teeth areas; and a fourth program for searching the database based on the identified one or more teeth characteristic elements and determining identification pass or fail according to a similarity between the teeth image of the person to be identified and a teeth image retrieved from the database.

The computer readable recording medium may be any type of medium on which data that may be read by a computer system may be recorded, for example, a ROM, a RAM, a CD-ROM, a magnetic tape, a floppy disc, or an optical data storage device. The present invention may also be realized as carrier waves (for example, transmitted through Internet). Alternatively, computer readable recording media are distributed among computer systems connected through a network so that the present invention may be realized as a code that is stored in the recording media and may be read and executed in the computers. Functional programs, codes, or code segments for implementing the present invention may be easily inferred by programmers skilled in the field of the present invention.

As described above, according to the present invention, in a situation requiring personal identification, for example, when a person enters a particular area, deposits or withdraws money at an automatic teller machine (ATM), or uses an electronic payment service through mobile communication equipment, personal identification is performed using a teeth image, which is simply recognizable and from which characteristic elements are simply isolated, thereby increasing a speed of personal identification and decreasing a cost for implementation.

In addition, the personal identification method and apparatus according to the present invention may be combined with conventional identification technology using a password in a simple stage or may be easily combined with conventional identification technology using a face, a fingerprint, an iris, veins in the back of the hand, or a voice when a high degree of personal identification is required.

Preferred embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of digital imaging for isolating a teeth area within a teeth image, comprising:
providing a teeth image of a person to be identified;
isolating an inner mouth area within the teeth image;
determining a position of an interline between an upper teeth portion and a lower teeth portion within the inner mouth area; and
isolating an upper teeth area and a lower teeth area based on the position of the interline.

2. The method as claimed in claim 1, wherein isolating the inner mouth area comprises:
defining first regions and second regions by performing thresholding on each pixel of the teeth image using a predetermined threshold value;
labeling contour portions of the second regions smaller than the first regions; and
selecting a region having a maximum area from among the labeled second regions and determining the selected region as the inner mouth area.

3. The method as claimed in claim 2, wherein defining the first and second regions comprises:
performing thresholding using at least one among red (R), green (G), and blue (B) color values of each pixel in the teeth image.

4. The method as claimed in claim 2, wherein defining the first and second regions comprises:
converting RGB color values of each pixel in the teeth image into Hue Saturation Intensity (HSI) color values and performing the thresholding using a converted I color value.

5. The method as claimed in claim 1, wherein determining the position of the interline comprises:
performing horizontal projection on the inner mouth area; and
determining the position of the interline based on a position at which a pixel accumulation value is at a maximum as the result of the horizontal projection.

6. The method as claimed in claim 1, wherein isolating the upper and lower teeth areas comprises:
extending an area having a similar color to each of seed points, which are respectively set at predetermined positions above and below the interline from the seed point.

7. The method as claimed in claim 1, wherein isolating the upper and lower teeth areas comprises:
setting a predetermined upper area and a predetermined lower area to have a rectangular shape based on the position of the interline; and
performing thresholding on the predetermined upper and lower areas using a predetermined threshold value.

8. A computer readable recording medium, comprising:
a first program for performing thresholding on a teeth image of a person to be identified using a predetermined threshold value and selecting a region having a maximum area from regions that are defined by performing labeling on thresholded pixels, thereby isolating an inner mouth area within the teeth image recorded thereon;
a second program for performing horizontal projection on the inner mouth area and determining a position of an interline between an upper teeth portion and a lower teeth portion based on a position at which a pixel accumulation value is at a maximum as the result of the horizontal projection recorded thereon; and
a third program for isolating upper and lower teeth areas based on the position of the interline recorded thereon.

9. A personal identification method using a digital image of teeth of a person to be identified, comprising:
(a) constructing a database by storing teeth images from a plurality of persons and at least one corresponding teeth characteristic element of each person;
(b) determining a position of an interline between an upper teeth portion and a lower teeth portion from an inner mouth area that is separated from a teeth image of the person to be identified, and isolating an upper teeth area and a lower teeth area based on the position of the interline;
(c) identifying one or more teeth characteristic elements from the upper and lower teeth areas; and
(d) searching the database based on the identified one or more teeth characteristic elements and determining identification pass or fail according to a similarity between the teeth image of the person to be identified and a teeth image retrieved from the database.

10. The personal identification method as claimed in claim 9, wherein determining the position of the interline comprises:
performing thresholding on each pixel in the teeth image using a predetermined threshold value, labeling the thresholded pixels, and selecting a region having a maximum area from among regions defined as a result of the labeling, as the inner mouth area.

11. The personal identification method as claimed in claim 10, wherein determining the position of the interline further comprises:
performing horizontal projection on the inner mouth area, and determining the position of the interline based on a position at which a pixel accumulation value is at a maximum as the result of the horizontal projection.

12. The personal identification method as claimed in claim 11, wherein determining the position of the interline further comprises:
extending an area having a similar color to each of seed points, which are respectively set at predetermined positions above and below the interline, from a respective seed point in order to isolate the upper and lower teeth areas.

13. The personal identification method as claimed in claim 11, wherein determining the position of the interline further comprises:
setting a predetermined upper area and a predetermined lower area to have a rectangular shape based on the position of the interline and performing thresholding on the predetermined upper and lower areas, in order to isolate the upper and lower teeth areas.

14. The personal identification method as claimed in claim 10, wherein performing the thresholding comprises:
using at least one among red (R), green (G), and blue (B) color values of each pixel in the teeth image.

15. The personal identification method as claimed in claim 10, wherein RGB color values of each pixel in the teeth image are converted into Hue Saturation Intensity (HSI) color values, and the thresholding is performed using a converted I color value.

16. The personal identification method as claimed in claim 9, wherein identifying one or more teeth characteristic elements comprises:
performing vertical projection on each of the isolated upper and lower teeth areas; and
obtaining information on the number of teeth in the upper and lower teeth areas, an area ratio between teeth, and a width ratio between teeth from the result of the vertical projection.

17. The personal identification method as claimed in claim 9, wherein identifying one or more teeth characteristic elements comprises:
obtaining information on shapes of teeth and teeth arrangement from an image pattern of the isolated upper and lower teeth areas.

18. The personal identification method as claimed in claim 9, wherein identifying one or more teeth characteristic elements comprises:
obtaining information on colors of teeth by obtaining a brightness histogram of the isolated upper and lower teeth areas.

19. The personal identification method as claimed in claim 9, wherein searching the database comprises:
searching the database using one of the detected teeth characteristic elements to identify candidate teeth images; and
searching the candidate teeth images using at least one teeth characteristic element from among the remaining teeth characteristic elements.

20. A computer readable recording medium comprising:
a first program for constructing a database by storing teeth images from a plurality of persons and at least one corresponding teeth characteristic element of each person recorded thereon;
a second program for determining a position of an interline between an upper teeth portion and a lower teeth portion from an inner mouth area that is isolated from a teeth image of a person to be identified, and isolating an upper teeth area and a lower teeth area based on the position of the interline recorded thereon;
a third program for identifying one or more teeth characteristic elements from the upper and lower teeth areas; and
a fourth program for searching the database based on the identified one or more teeth characteristic elements and determining identification pass or fail according to a similarity between the teeth image of the person to be identified and a teeth image retrieved from the database.

21. A personal identification apparatus using a teeth image, comprising:
a teeth image database, which stores teeth images from a plurality of persons and at least one corresponding teeth characteristic element of each person;
a teeth image acquisition unit for acquiring a teeth image of a person to be identified;
a teeth isolator for performing a first thresholding on the teeth image provided from the teeth image acquisition unit to separate an inner mouth area, for performing horizontal projection on the inner mouth area to determine a position of an interline between an upper teeth portion and a lower teeth portion, and for isolating a teeth area based on the position of the interline;
a characteristic detector for performing vertical projection on the isolated teeth area to identify one or more teeth characteristic elements;
a search section for searching the teeth image database using at least one of the teeth characteristic elements identified by the characteristic detector; and
an identification section for determining identification pass or fail according to a similarity between the teeth image of the person to be identified and a teeth image searched from the search section.

22. The personal identification apparatus as claimed in claim 21, wherein the teeth isolator extends an area having a similar color to each of seed points, which are respectively set at predetermined positions above and below the interline, from a respective seed point in order to isolate the teeth area.

23. The personal identification apparatus as claimed in claim 21, wherein the teeth isolator sets a predetermined upper area and a predetermined lower area to have a rectangular shape based on the position of the interline and performs a second thresholding on the predetermined upper and lower areas to isolate the teeth area.

24. The personal identification apparatus as claimed in claim 21, wherein the characteristic detector obtains a brightness histogram of the isolated teeth area in addition to the vertical projection on the teeth area.

25. The personal identification apparatus as claimed in claim 21, wherein the search section searches the teeth image database using one of the identified teeth characteristic elements to identify candidate teeth images, and searches only the candidate teeth images using at least one teeth characteristic element from among the remaining teeth characteristic elements.
